(19) United States
(12) Patent Application Publication
(10) Pub. No.: US 2002/0188550 A1
(43) Pub. Date: Dec. 12, 2002

(54) Method for marketing demographic-directed printed media

(76) Inventors: Scott J. Swartz, Houston, TX (US); Tamera Alwine, Houston, TX (US)

Correspondence Address: Eric D. Cohen, Welsh & Katz, Ltd., 22nd Floor, 120 South Riverside Plaza, Chicago, IL, 60606, US

(21) Appl. No.: 10/002,384

(22) Filed: Oct. 26, 2001

Related U.S. Application Data
(60) Provisional application No. 60/296,700, filed on Jun. 7, 2001.

(51) Int. Cl. G06F 17/60

(52) U.S. Cl. 705/37

(57) ABSTRACT

A method of targeting potential customers with printed advertising media of a seller includes the steps of a) identifying a customer base of a plurality of video product-rental establishments, b) determining customer demographic criteria corresponding to the customer base of each establishment, c) determining seller demographic criteria corresponding to the seller's printed advertising media, d) calculating a desired advertising coverage area of the seller e) selecting the video-rental establishments in the desired coverage area whose customer base has customer demographic criteria that match the seller demographic criteria, and f) providing each selected video-rental establishment with the seller's printed advertising media, where the printed advertising media is adapted to attach to an enclosure of the video product so that the potential customers in the customer base are exposed to the seller's printed advertising media.

### CROSS-REFERENCE TO RELATED APPLICATIONS

This application claims the benefit of priority from copending provisional patent application Serial No. 60/296,700, filed on Jun. 7, 2001, entitled Mini-Billboard In Every Home. Provisional patent application Serial No. 60/296,700 is incorporated herein by reference in its entirety.

### FIELD OF THE INVENTION

The present invention relates generally to a targeted marketing method and more specifically to a marketing method that targets a customer with media attached to a video product, such as a video tape, based upon demographic criteria.

### BACKGROUND OF THE INVENTION

Various marketing and advertising techniques exist to entice a potential customer to buy a seller's goods or services. Wide area advertising, such as newspaper and magazines, radio, television, “yellow pages,” and outdoor advertising is very popular and abundant. Newspaper advertisements, however, are not targeted to a specific audience and are often “buried” in many pages of newsprint. Further, newspaper readership has been declining over the last several years. Additionally, it is very expensive to run color advertisements in newspapers.

Yellow page advertising receives only sporadic viewing, can only be modified annually, and does not target the consumer. Additionally, yellow page advertisements list ones competitors advertisements next to your advertisement and are expensive, particularly if produced in color. Further, yellow page advertising is often unavailable for several weeks to a new resident due to delays associated with arranging new telephone service.

Similarly, outdoor advertising, such as billboards and building signage, cannot generally target the consumer, is relatively expensive, and receives limited exposure. Additionally, such advertisements are not easily changed, and are often subject to municipal restrictions, which limit their effectiveness.

A need exists for a cost-competitive method for targeting potential buyers with fall color advertisements such that the advertisements receive high exposure.

### SUMMARY OF THE INVENTION

The disadvantages of present marketing methods are substantially overcome with the present invention by providing a novel method for targeting a customer with media, which is attached to a video product, such as a video tape or DVD, based upon demographic criteria.

More specifically, one embodiment of the present method of targeting potential customers with printed advertising media of a seller includes the steps of a) identifying a customer base of a plurality of video product-rental establishments, b) determining customer demographic criteria corresponding to the customer base of each establishment, c) determining seller demographic criteria corresponding to the seller's printed advertising media, d) calculating a desired advertising coverage area of the seller e) selecting the video-rental establishments in the desired coverage area whose customer base has customer demographic criteria that match the seller demographic criteria, and f) providing each selected video-rental establishment with the seller's printed advertising media, where the printed advertising media is adapted to attach to an enclosure of the video product so that the potential customers in the customer base are exposed to the seller's printed advertising media.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a flowchart illustrating the steps of a specific embodiment of according to the present method;

FIG. 2 is a pictorial illustration of a video tape container and a media insert; and

FIG. 3 is a pictorial illustration of a video tape container and a media insert.

### DETAILED DESCRIPTION OF THE INVENTION

In this written description, the use of the disjunctive is intended to include the conjunctive. The use of definite or indefinite articles in not intended to indicate cardinality. In particular, a reference to “the” object or thing or “an” object or “a” thing is intended to also describe a plurality of such objects or things.

It is to be further understood that the title of this section of the specification, namely, “Detailed Description of the Invention” relates to Rules of the U.S. Patent and Trademark Office, and is not intended to, does not imply, nor should be inferred to limit the subject matter disclosed herein or the scope of the invention.

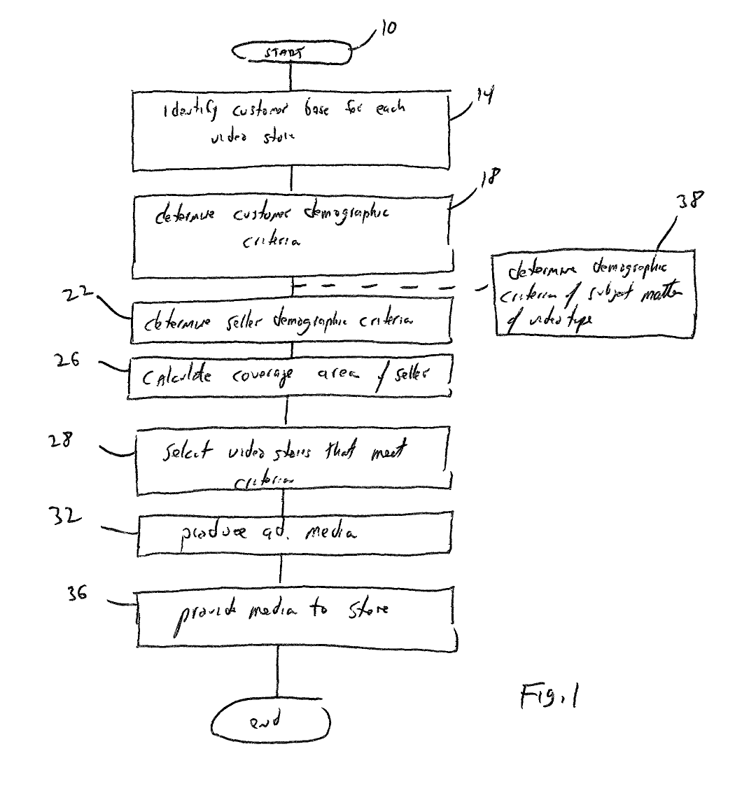

Referring to FIG. 1, the present inventive method will be described. The present marketing method targets potential customers of a customer base with printed advertising media of a seller, and begins at a step 10. In particular, video product-rental establishments carry the seller's printed media, which is attached to an enclosure of the video product. Such establishments are typically stores that rent video tapes, but may also sell video tapes as well. Of course, the video product-rental establishment may also rent and/or sell, CD ROM, compact disc, DVD disc, laser disc, video game cartridges or any video media now in existence or developed in the future. For purposes of illustration only, the term “video tape” will be used herein to describe any and all of the aforementioned video media products.

The seller is typically an entity, such as for example, an automobile dealer, construction contractor, real estate broker, or any person or entity wishing to advertise its goods or services. It is known that advertising often increase sales. However, there is a cost-benefit associated with advertising, and some forms of advertising are more cost effective than others. Many interrelated factors determine the effectiveness of advertising, such as the persuasiveness of media and/or the advertisement itself, exposure or duration that the advertisement is viewed by the potential customer, the frequency that the advertisement is viewed by the potential customer, the format of the advertisement presented to the potential customer, and the like. It has been determined that color print media is superior to black and white print media with respect to customer retention and identification. Advertising in the form of color printed media affixed to the jacket or enclosure of the video tape is particularly effective because the enclosure typically remains in plain view of the potential customer for the duration of the rental period, which may, for example be between one and five days. During this time, the video tape enclosure, and hence, the printed media may be placed on a coffee table, entertainment console or other furniture in the potential customer's living room, bedroom or den. Accordingly, the potential customer is frequently exposed to the seller's advertising media.

Additionally, it is known that persons moving into new residences do not typically immediately have access to yellow page directories, cable or satellite-based television, regular newspaper subscription, and the like because such services typically require several days or weeks to establish and/or acquire. Persons just moving into new residences do, however, rent video tapes in fairly high numbers because the other media, as described above, may not be immediately or conveniently available soon after a move or relocation. Accordingly, advertisements in the form of printed media attached to the video tape enclosure are particularly effective. Essentially, the potential customer is a captive audience. Such advertising is essentially a “mini-billboard” in the potential customer's living room.

One of the first steps in the present method is to identify the customer base of a plurality of video product-rental establishments, as shown in a step 14. This means identifying the customers who are typically serviced by a particular video rental store in a particular geographical region. The term video store or video rental store is used interchangeably with the term video product-rental establishment, whether the video products are rented or sold outright. Demographic studies have indicated that in a city or urban setting, one video store typically services people within about a five square mile area. In suburban areas, one video store typically services people within about a seven square mile area, and in rural areas, one video store typically services people within about a ten to twelve square mile area. Of course, these figures are only average figures, and may vary significantly depending upon the part of the country sampled.

The customer base represents those individuals in the geographical service area corresponding to the video store. The customer base represents potential buyers of the seller's goods or services who happen to reside in the geographical area serviced by the video store. Of course, in some situations, there may be more than one video store in a particular area, especially in metropolitan areas. In this case, the customer bases will overlap.

Once the customer base for each video store had been established, demographic criteria corresponding to the customer base may be determined, as shown in a step 18. Such demographic data may include, for example, age (whether adult, teenager, child, toddler etc.), income level (median and mean), home ownership/rental status, race, marital status, religion, gender, national origin, ethnic makeup, number of children and age of children. Other demographic criteria may include media sophistication, such as whether the person own VCRs, satellite dishes, or subscribes to cable TV and the like. Of course, some, part of, or all of the demographic criteria may be of interest to the seller in targeting the customer base with the seller's advertising media, depending upon the seller's goods and services.

The customer demographic criteria corresponding to the customer base may be obtained in different ways. Such demographic data may, for example, be obtained by conducting interviews with personnel or employees at the video product-rental establishment. This may be as informal as asking probing question of the video store personnel to determine the general income level of the store's customers or those in the general neighborhood. Such data may be limited to broad categories, such as affluent, middle-class, or lower income. Of course, unless the video store personnel know significant details regarding a majority of their customers or those in the general neighborhood, the demographic data may be limited. Alternatively, the video store personnel may be asked to fill out written questionnaires regarding their observations of the various individuals in the neighborhood, from which demographic data may be gleaned.

In an alternate embodiment, the customer demographic criteria corresponding to the customer base may be obtained from census data, municipal records (real estate transfer, marriage licenses), governmental records (driver licenses), public records, and marketing databases. Additionally, marketing specialists exist that provide many types of demographic data based on geographic location. For example, the web site identified as Adage.com provides an abundance of demographic information.

Once customer demographic data has been obtained for the customer base corresponding to the video stores participating in the present marketing method, interested sellers are processed so as to determine the seller demographic criteria, as shown in a step 22. Preferably, the seller will give the provider of the present marketing method the pertinent demographic criteria to which its advertising media is directed, because most sellers known their target audience. For example, the seller of luxury automobiles typically directs its advertising to the affluent customer. Perhaps the seller has defined an income level threshold for potential customers below which an individual would be disqualified from being considered as a potential customer. Generally, the seller demographic criteria may include some or all of the customer demographic criteria listed above. Typically, however, the scope and depth of the customer demographic criteria obtained is greater than that of the seller's demographic criteria so that any particular demographic criterion deemed important by the seller can be found and targeted within the customer base.

Next, the seller must define the geographical area or desired advertising coverage area in which its advertisement will be offered, as shown in a step 26. This is basically the desired range or reach of the seller's advertising. For example, the seller may want a national advertising campaign if the product reaches a national audience. Perhaps, for example, a national advertising campaign is well-suited to an automobile manufacturer, such as Ford, Lexus and the like, where its products may be sold to anyone through out the country. On the other hand, a regional advertising campaign may be better suited to a particular automobile dealer who expects to sell automobiles only to persons within, for example, one portion of the state. Typically, the advertising coverage area would include within its boundaries many video stores along with their corresponding customer bases. Essentially, defining the desired advertising coverage area determines which video stores are candidates for receiving the seller's printed media. The seller typically makes this choice.

Although the desired advertising coverage area essentially defines which participating video stores are possible candidates, not all of candidate video stores will be ultimately selected. Moreover, only video-rental establishments in the desired coverage area whose customer base has customer demographic criteria that match the seller demographic criteria are selected. Such a match may be based on one or more demographic criteria. For example, a seller may want to direct its advertising to all persons having an income over $100,000 per year, regardless of any other demographic criteria. In that case, all participating video stores within the desired advertising coverage area whose customer base indicated an affluent characteristic, namely income over $100,000 per year, would be selected to receive the seller's printed media, and others would be excluded. Of course, many combinations of demographic criteria may be used to target the customer base. For example, the seller may want to only target males in the 35-50 age range having an income of less than $40,000 per year.

All video stores within the desired advertising coverage area whose customer base has customer demographic criteria that match the seller demographic criteria are then selected to receive the seller's printed advertising media, which media is affixed or attached to the containers of the video tapes, as shown in a step 28. The printed media is then produced, as shown in a step 32, and is then provided to the video store to be affixed to the video tape containers, as shown in a step 36. Of course, the seller's printed media is affixed to a predetermined number of video tape containers, depending upon the amount that the seller is willing to spend.

In an alternate embodiment, the present method may further include the step of identifying a subject matter of the video product and determining video-product demographic criteria corresponding to that subject matter. Thus, each video tape title carried by the video store may be identified with respect to the video-product demographic data, as shown in an optional step 38. This means, for example, that a Disney cartoon video tape may be identified with the demographic label of “children,” or some appropriate age designation. Thus, if a seller's demographic criteria included the criterion of “children,” then in addition to the steps described above, the seller's media would only be affixed to video tape enclosures corresponding to the seller's criterion of “children,” such as the aforementioned Disney product.

As another example, certain action films may be directed to a target audience of males in the age group of 16 to 45 years of age, and may receive a criteria such as “fast action film”. A seller of very expensive sports cars, for example, may target potential customers who are single males who have an income level of over $125,000. The seller may have also determined that those viewing exciting fast action films are likely customers. Accordingly, the present method permits selection of the video product rental establishments whose customers are single males typically have income levels over $125,000. In addition, in those selected stores, color printed media advertising the seller's expensive sports cars are attached only to video products having demographic criteria directed to fast action films, such as James Bond, Top Gun and the like. Accordingly, in this way, the potential customers in the customer base are specifically targeted. This occurs for every selected video product rental establishment in the seller's desired advertising coverage range, which is typically determined by geographical boundaries. Note that the order of steps 14, 18, 22, 26, and 38 is not absolute, and such order of step may be modified without departing from the scope of the method.

In operation, the present marketing method provides an incentive to the video store to carry the seller's advertising. In particular, the owner or shareholders of the video store are paid a fee for each video tape container upon which the seller's advertising is affixed. For example, the video store owner may be paid $0.50 for each container upon which the advertising is affixed, for a predetermined period of time, for example, one month.

For example, the first side of the video tape enclosure may receive a first seller's advertising media, while the second side of the enclosure may receive a second seller's advertising media. In this case, the video store owner would receive, for example, $0.50 regardless of whether one or two advertisements were affixed to the video tape enclosure. Of course, this amount is multiplied by the number of corresponding video tapes. Also, the amount of the fees paid to the video store owner may vary without departing from the scope of the present method. Additionally, from a marketing viewpoint, it is important to note that the first and second seller's advertising media are directed to non-competing goods or services because it is reasonable that sellers would not want a competitors advertisement placed adjacent to their own.

Alternatively, one seller may desire to have the same advertisement appear on both sides of the video tape enclosure, or may wish to have different advertisements (from the one seller) appearing on the enclosure. In some situations, perhaps only one side of the video tape enclosure may receive the advertising media.

The above-identified incentive or carrying fee becomes substantial when the number of video tapes in a typical video-rental store are considered. For example, the average Blockbuster Video store stocks about 8,000 video tapes (not titles). If each of the 8,000 video tape enclosures carry advertisements, the fee received by the video store is $4,000 per month, which amounts to $48,000 per year for one particular video store.

On the other hand, the provider of the present marketing method makes a profit because the seller is also charged a fee. As an illustrative example, the seller may be charged $3.50 per month for each advertisement that is placed in one side of the video tape enclosure, or $7.00 per month for advertising on both sides of the enclosure. Based upon known average circulation numbers of video tapes within typical customer bases, the fees charged to the seller are competitive with other media, such a newsprint with respect to fall color advertisements. The profit would then be about $6.50 per month per video tape enclosure. The profit is represented by the difference between the amount that the seller is charged and the amount of the carrying fee that is paid to the video store owner.

With respect to the seller's printed advertising media, the dimensions are dictated by the dimensions of the video tape enclosures, which are typically four inches wide by seven inches long. Of course, the dimensions would change for use with a DVD disk or laser disk and the like. As described above, color printed media is more effective than black and white media. Typically, the seller may provide the advertising copy or computer file to the provider of the present marketing method. In one embodiment, the provider of the present method would configure the advertising copy for the appropriate dimensions and create advertising “inserts” or “stick-on.” The advertising inserts would then be affixed to or inserted into the requisite number of video tape enclosures by either the provider of the present method, video store personnel, or by a third party.

The advertisement may be affixed or attached to the enclosure in a variety of different ways. Preferably, the advertising media is contained within the enclosure of the video product and is “inserted” into the enclosure and is retained between the inside cover of the enclosure and the video tape. Because the container is preferably substantially translucent or transparent, the advertisement may be viewed through the enclosure.

Alternatively, the advertising media may be removeably affixed to a surface portion of the enclosure with a mild adhesive material, or a non-residue adhesive. Also, a pressure-sensitive material may be used. The advertisement may be applied to either the outside surface or the inside surface of the enclosure. If the enclosure is translucent or transparent, the advertisement may be applied to the inside surface so that the advertisement may be viewed through the enclosure.

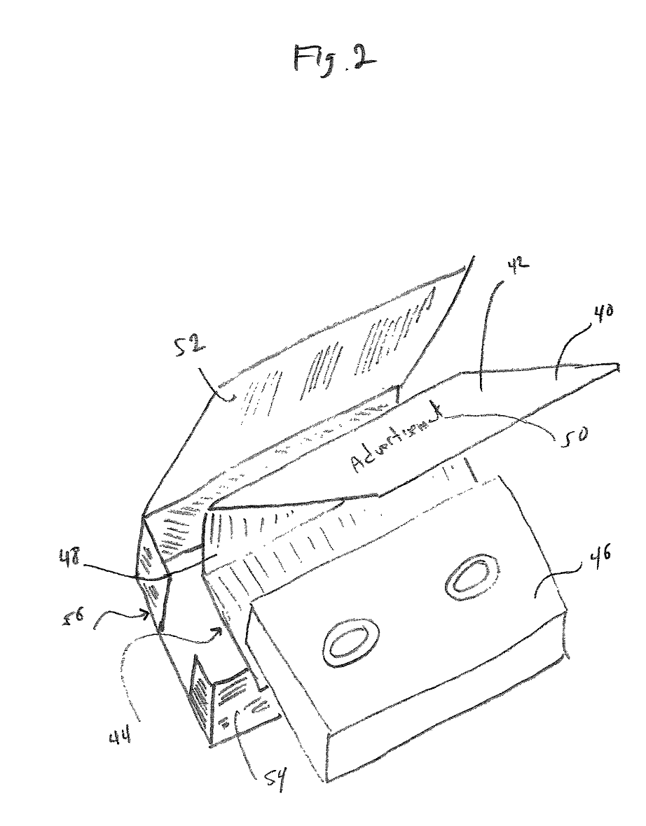

Referring now to FIG. 2, the advertising media may be produced in the form a folded insert 40 having a first side 42, and a second side 44. The insert 40 is dimensioned to fit about two sides of the video tape 46, and also includes a blank area 48 to accommodate the thickness of the video tape. 46. Thus, the insert 40 may, for example, include two four inch by seven inch panels, having printed thereon the full color advertisements 50 attached by the 1.5 inch by seven inch blank area 48. Preferably, the insert 40 is printed as a single sheet of paper and is folded accordingly to fit.

The first side 42 having the color advertisement is visible through the transparent first portion 52 of the transparent or translucent video tape enclosure 54. Similarly, the second side 44 having the color advertisement is also visible through the transparent or translucent second portion 56 of the video tape enclosure 54. Again, the insert 40 may be appropriately dimensioned to attach to or fit within the enclosure for a different video product, such as the aforementioned DVD disk, laser disk, and the like.

Alternatively, the insert may “slip into” the video tape container and be frictionally retained therein. This may be the case when using video tape containers having a single open end and flexible pressure-folding tabs that prevent the video tape from falling out, as is known in the art. Preferably, the advertising insert is lightly held in place with a small pad of non-residue adhesive or pressure-sensitive material, as described above.

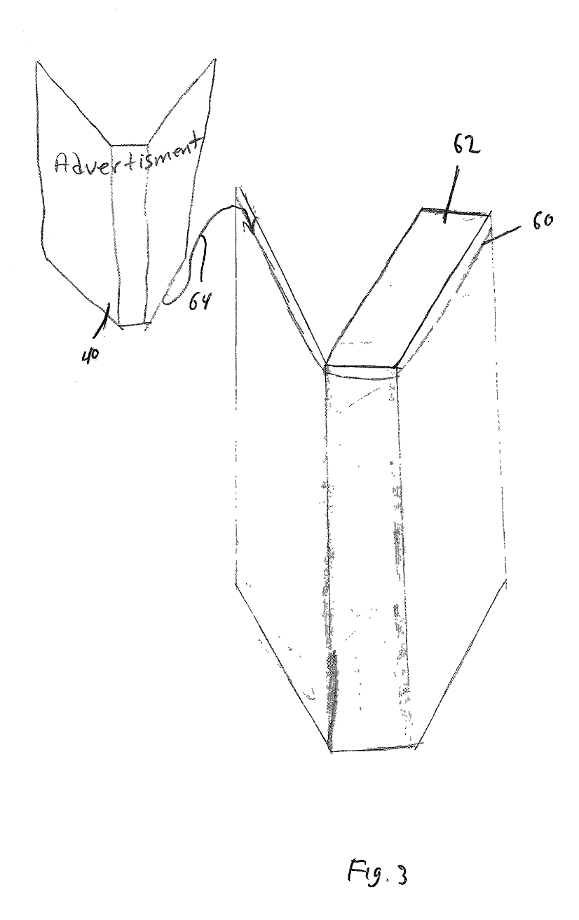

Referring to FIG. 3, preferably, the advertising insert 40 fits between a transparent plastic sleeve 60 that is affixed to the video tape enclosure 62, and the enclosure itself, as shown by an arrow 64. The advertising insert 40 is held in place via a frictional fit, or alternatively, a suitable non-residue adhesive may be used. In this situation, the video tape enclosure 62 need not be translucent or transparent. Only the plastic sleeve 60 need be translucent or transparent.

Specific embodiments of a method for marketing demographic-directed printed media according to the present method have been described for the purpose of illustrating the manner in which the method may be made and used. It should be understood that implementation of other variations and modifications of the method and its various aspects will be apparent to those skilled in the art, and that the method is not limited by the specific embodiments described. It is therefore contemplated to cover by the present invention any and all modifications, variations, or equivalents that fall within the true spirit and scope of the basic underlying principles disclosed and claimed herein.

What is claimed is:

1. A method of targeting potential customers of a customer base with printed advertising media of a seller, method comprising the steps of:
a) identifying the customer base of a plurality of video product-rental establishments;
b) determining customer demographic criteria corresponding to the customer base of each establishment;
c) determining seller demographic criteria corresponding to the seller's printed advertising media;
d) calculating a desired advertising coverage area of the seller;
e) selecting the video-rental establishments in the desired coverage area whose customer base has customer demographic criteria that match the seller demographic criteria; and
f) providing each selected video-rental establishment with the seller's printed advertising media, said printed advertising media adapted to attach to an enclosure of the video product offered by the establishment so that the potential customers in the customer base are exposed to the seller's printed advertising media.

2. The method according to claim 1 wherein the seller's advertising media is color printed media.

3. The method according to claim 1 wherein the seller's advertising media is attached to a predetermined number of enclosures of the video product and wherein a carrying fee is paid to the video product-rental establishment.

4. The method according to claim 3 wherein the seller pays an advertising fee that is greater than the carrying fee paid to the video product-rental establishment.

5. The method according to claim 3 where a difference between the advertising fee paid by the seller and the carrying fee paid to the establishment represents a profit.

6. The method according to claim 1 wherein a first side of the enclosure of the video product receives a first seller's advertising media, and a second side of the enclosure of the video product receives a second seller's advertising media.

7. The method according to claim 6 wherein the first and second seller's advertising media are directed to non-competing goods or services.

8. The method according to claim 1 wherein a first side and a second side of the enclosure of the video product receive the seller's advertising media.

9. The method according to claim 1 wherein at least one side of the enclosure of the video product receives the seller's advertising media.

10. The method according to claim 1 wherein the advertising media is removeably affixed to a surface portion of the enclosure of the video product.

11. The method according to claim 10 wherein the advertising media is removeably affixed to a portion of the enclosure with an adhesive material.

12. The method according to claim 10 wherein the advertising media is removeably affixed to a portion of the enclosure with pressure-sensitive material disposed between the advertising media and the surface portion of the enclosure.

13. The method according to claim 1 wherein the advertising media is contained within the enclosure of the video product.

14. The method according to claim 1 wherein the advertising media is contained within the enclosure of the video product, and the enclosure is translucent so that the advertising media is viewed through the enclosure.

15. The method according to claim 1 wherein the advertising media is contained within the enclosure of the video product, and the enclosure is substantially transparent so that F the advertising media is viewed through the enclosure.

16. The method according to claim 1 wherein the advertising media is retained against an inside portion of the enclosure of the video product.

17. The method according to claim 1 wherein the video product is selected from the group consisting of a video tape, CD ROM, compact disc, DVD disc, laser disc and video game cartridges.

18. The method according to claim 1 wherein the customer demographic criteria is selected from the group consisting of age, income level, home ownership/rental status, race, marital status, religion, gender, national origin, ethnic makeup, number of children and age of children.

19. The method according to claim 1 wherein the seller demographic criteria is selected from the group consisting of age, income level, home ownership/rental status, race, marital status, religion, gender, national origin, ethnic makeup, number of children and age of children.

20. The method according to claim 1 wherein the seller demographic criteria is provided by the seller.

21. The method according to claim 1 wherein the step of determining the customer demographic criteria further includes the step of obtaining data from sources selected from the group consisting of census data records, municipal records, governmental records, public records, and marketing databases.

22. The method according to claim 1 wherein the step of determining the customer demographic criteria further includes the step of obtaining customer demographic data by interviewing employees of the video product-rental establishment.

23. The method according to claim 1 further including the step of identifying a subject matter of the video product and determining video-product demographic criteria corresponding to the subject matter.

24. The method according to claim 23 wherein the seller's printed advertising media is attached only to video products having the video-product demographic criteria that match the seller demographic criteria.

25. A method of targeting potential customers of a customer base with printed advertising media of a seller, method comprising the steps of:
identifying a customer base of a plurality of video product-rental establishments;
determining customer demographic criteria corresponding to the customer base of each establishment;
determining video-product demographic criteria corresponding to a subject matter of the video product;
determining seller demographic criteria corresponding to the seller's printed advertising media;
calculating a desired advertising coverage area of the seller;
identifying the video-rental establishments in the desired coverage area having said customer demographic criteria that match the seller demographic criteria; and
providing each identified video-rental establishment with the seller's printed advertising media, said printed advertising media adapted to attach to an enclosure of the video product offered by the establishment so that the potential customers in the geographical target zone are exposed to the seller's printed advertising media, wherein the seller's printed advertising media is attached only to video products having the video-product demographic criteria that match the seller demographic criteria.
